(19) United States
(12) Patent Application Publication
(10) Pub. No.: US 2022/0237464 A1
(43) Pub. Date: Jul. 28, 2022

(54) METHOD, ELECTRONIC DEVICE, AND COMPUTER PROGRAM PRODUCT FOR TRAINING AND DEPLOYING NEURAL NETWORK

(71) Applicant: EMC IP Holding Company LLC, Hopkinton, MA (US)

(72) Inventors: Wenbin Yang, Shanghai (CN); Jinpeng Liu, Shanghai (CN); Jiacheng Ni, Shanghai (CN); Zhen Jia, Shanghai (CN)

(21) Appl. No.: 17/190,557

(22) Filed: Mar. 3, 2021

(30) Foreign Application Priority Data
Jan. 28, 2021 (CN) 202110121131.5

(51) Int. Cl. G06N 3/08; G06F 9/50

(52) U.S. Cl. CPC G06N 3/082; G06F 9/5044; G06F 9/505

(57) ABSTRACT

Embodiments of the present disclosure relate to a method, an electronic device, and a computer program product for training and deploying a neural network. According to an example implementation of the present disclosure, a method for training a neural network includes: determining a group of optimal network structures for a prunable neural network under various operation workloads based on a training data set; and training the prunable neural network based on the training data set and the group of optimal network structures, such that the trained prunable neural network has, under a given operation workload, an optimal network structure corresponding to the given operation workload. In this way, the prunable neural network under various operation workloads may be determined in a training process, such that the corresponding prunable neural network may be deployed into various devices based on the operation workloads in a deployment process.

### RELATED APPLICATION(S)

The present application claims priority to Chinese Patent Application No. 202110121131.5, filed Jan. 28, 2021, and entitled “Method, Electronic Device, and Computer Program Product for Training and Deploying Neural Network,” which is incorporated by reference herein in its entirety.

### FIELD

Embodiments of the present disclosure generally relate to information processing, and specifically relate to a method, an electronic device, and a computer program product for training and deploying a neural network.

### BACKGROUND

Complexity of a neural network, such as a deep learning network, may be measured based on an operation workload, such as floating point operations per second (FLOPs). When an operation workload of a neural network is given, the operation workload will determine a duration required for the neural network to perform inference on a device. For inference applications used in many various heterogeneous devices, in order to meet response time requirements (for example, 5 milliseconds), the neural network may be compressed to various compression ratios, thereby reducing the operation workload of the neural network. For example, a graphics processing unit (GPU) has lower requirements for response time, while a central processing unit (CPU) has higher requirements for response time. Therefore, for the GPU, the neural network may be compressed to a lower compression ratio to obtain a high inference accuracy. For the CPU, the neural network may be compressed to a higher compression ratio to achieve real-time response. However, a conventional compression mode of the neural network is inefficient.

### SUMMARY

Embodiments of the present disclosure provide a method, an electronic device, and a computer program product for training and deploying a neural network.

In a first aspect of the present disclosure, a method for training a neural network is provided. The method includes: determining a group of optimal network structures for a prunable neural network under various operation workloads based on a training data set; and training the prunable neural network based on the training data set and the group of optimal network structures, such that the trained prunable neural network has, under a given operation workload, an optimal network structure corresponding to the given operation workload.

In a second aspect of the present disclosure, a method for deploying a neural network is provided. The method includes: acquiring a trained prunable neural network, the prunable neural network being trained to have, under a given operation workload, an optimal network structure corresponding to the given operation workload; determining, based on information and an expected performance related to a target device, a target operation workload to be applied to the target device; and deploying the prunable neural network to the target device based on the target operation workload, the deployed prunable neural network having an optimal network structure corresponding to the target operation workload.

In a third aspect of the present disclosure, an electronic device is provided. The device includes at least one processing unit and at least one memory. The at least one memory is coupled to the at least one processing unit and stores an instruction for execution by the at least one processing unit. The instruction, when executed by the at least one processing unit, causes the device to execute actions. The actions include: determining a group of optimal network structures for a prunable neural network under various operation workloads based on a training data set; and training the prunable neural network based on the training data set and the group of optimal network structures, such that the trained prunable neural network has, under a given operation workload, an optimal network structure corresponding to the given operation workload.

In a fourth aspect of the present disclosure, an electronic device is provided. The device includes at least one processing unit and at least one memory. The at least one memory is coupled to the at least one processing unit and stores an instruction for execution by the at least one processing unit. The instruction, when executed by the at least one processing unit, causes the device to execute actions. The actions include: acquiring a trained prunable neural network, the prunable neural network being trained to have, under a given operation workload, an optimal network structure corresponding to the given operation workload; determining, based on information and an expected performance related to a target device, a target operation workload to be applied to the target device; and deploying the prunable neural network to the target device based on the target operation workload, the deployed prunable neural network having an optimal network structure corresponding to the target operation workload.

In a fifth aspect of the present disclosure, a computer program product is provided. The computer program product is tangibly stored on a non-transitory computer-readable medium and includes a machine-executable instruction. The machine-executable instruction, when executed, causes a machine to implement any step of the method according to the first aspect of the present disclosure.

In a sixth aspect of the present disclosure, a computer program product is provided. The computer program product is tangibly stored on a non-transitory computer-readable medium and includes a machine-executable instruction. The machine-executable instruction, when executed, causes a machine to implement any step of the method according to the second aspect of the present disclosure.

This Summary is provided to introduce a selection of concepts in a simplified form, which will be further described in the Detailed Description below. The Summary is neither intended to identify key features or essential features of the present disclosure, nor intended to limit the scope of the present disclosure.

### BRIEF DESCRIPTION OF THE DRAWINGS

By more detailed description of example embodiments of the present disclosure with reference to the accompanying drawings, the above and other objectives, features, and advantages of the present disclosure will become more apparent, where identical reference numerals generally represent identical components in the example embodiments of the present disclosure.

FIG. 1 shows a schematic diagram of an example environment in which some embodiments of the present disclosure can be implemented;

FIG. 2 shows a flowchart of an example method for training a neural network according to some embodiments of the present disclosure;

FIG. 3 shows a schematic diagram of an example of compressing a prunable neural network according to some embodiments of the present disclosure;

FIG. 4 shows a flowchart of an example method for deploying a neural network according to some embodiments of the present disclosure; and

FIG. 5 shows a schematic block diagram of an example device that may be configured to implement embodiments of contents of the present disclosure.

Identical or corresponding reference numerals in the figures represent identical or corresponding parts.

### DETAILED DESCRIPTION

Illustrative embodiments of the present disclosure will be described in more detail below with reference to the accompanying drawings. The illustrative embodiments of the present disclosure are shown in the accompanying drawings. However, it should be understood that the present disclosure can be implemented in various forms without being limited to the embodiments set forth herein. In contrast, these embodiments are provided to make the present disclosure more thorough and complete, and fully convey the scope of the present disclosure to those skilled in the art.

The term “including” and variants thereof used herein denote open-ended inclusion, i.e., “including, but not limited to.” Unless otherwise specifically stated, the term “or” denotes “and/or.” The term “based on” denotes “at least partially based on.” The terms “an example embodiment” and “an embodiment” denote “at least one example embodiment.” The term “another embodiment” denotes “at least one additional embodiment.” The terms “first,” “second,” and the like may refer to different or identical objects. Other explicit and implicit definitions may be further included below.

As mentioned above, for inference applications used in various heterogeneous devices, in order to meet response time requirements, a neural network may be compressed to various compression ratios, thereby reducing the operation workload of the neural network. However, a conventional compression mode of the neural network is inefficient.

For example, devices on various platforms may be changed dynamically. Conventionally, a compression mode of the neural network needs to be customized for each different device. Apparently, this solution is very inefficient and is time-consuming. Especially, when there is an unforeseen device, the solution cannot be used.

In addition, conventionally, when the neural network is compressed, each layer of the neural network is usually compressed to an identical ratio. For example, when it is necessary to compress an operation workload of the neural network by 50%, channels in each layer of the neural network are compressed by 50%. In this case, different effects of different layers on a performance of the neural network are not considered. Therefore, it cannot obtain a neural network with the best performance after compression.

As an example, an edge computing environment with many accelerators is heterogeneous. These accelerators may have limited support for mathematical operations defined by the neural network, but edge inference applications have response time requirements. For example, an autonomous driving system has to, in response to a detected signal, reduce speed, make a turn, or change a lane. A lower limit of response time may be approximately determined by the operation workload of the neural network. For example, assuming that an operation workload of a neural network such as S-ResNet-50 is 4.1G FLOPs, an operational capability of a GPU is 100T FLOPs, and an operational capability of a CPU is 289G FLOPs, then the neural network will spend at least 4.1×10⁻⁵ seconds in inference on the GPU, and will spend at least 1.4×10⁻² seconds in inference on the CPU. Therefore, in order to save inference time, a compressed neural network may be used for inference while reducing accuracy.

Conventionally, the operation workload of the neural network may be reduced by the following approach. For example, first, an acceptable threshold accuracy and threshold response time of inference may be defined. Second, a target device may be specified, and an operational capability of the target device may be acquired from its hardware specifications. Then, the following steps may be executed iteratively: (a) compressing the neural network and recording a current operation workload and a current accuracy of the compressed neural network; (b) proceeding to the following step (c) when the current accuracy>the threshold accuracy; otherwise, returning an error to indicate that the target device cannot meet the requirements; (c) computing the current response time by the following approach: current response time=operation workload of the neural network/operational capability of the target device; and (d) returning a success message, and using the compressed neural network for inference when the current response time<threshold response time; otherwise, returning to step (a) to recompress the neural network. Apparently, a conventional solution to reduce the operation workload of the neural network is very time-consuming and needs to be executed for each different device.

According to example embodiments of the present disclosure, an improved solution for training and deploying a neural network is presented. In this solution, a group of optimal network structures for a prunable neural network under different operation workloads may be determined based on a training data set in a training process. Therefore, the prunable neural network may be trained based on the training data set and the group of optimal network structures, such that the trained prunable neural network has, under a given operation workload, an optimal network structure corresponding to the given operation workload.

Further, a trained prunable neural network may be acquired in a deployment process. In addition, based on information and an expected performance related to a target device, a target operation workload to be applied to the target device may be determined. Therefore, a prunable neural network may be deployed to the target device based on the target operation workload. The deployed prunable neural network has an optimal network structure corresponding to the target operation workload.

In this way, the prunable neural network under various operation workloads may be determined in a training process, such that the corresponding prunable neural network may be deployed into various devices based on the operation workload in a deployment process. Therefore, a fast real-time response and a high inference accuracy may be achieved for any device without the need of training the neural network for each device.

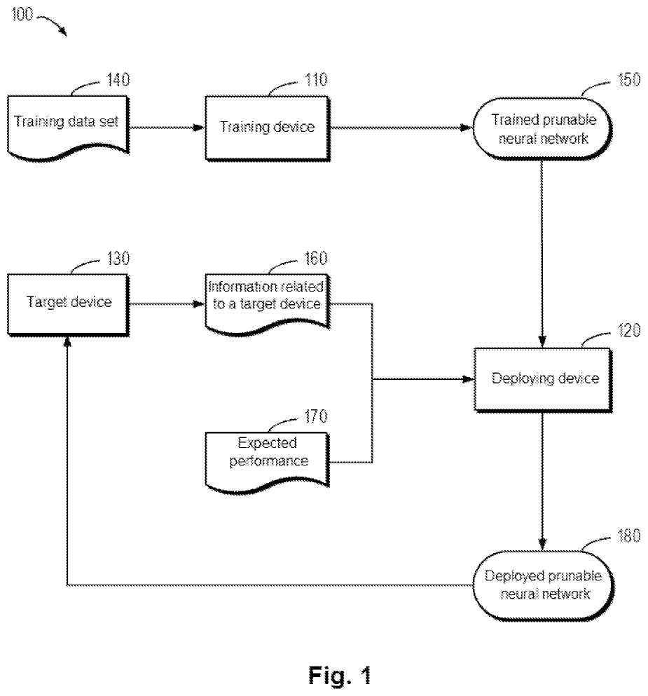

FIG. 1 shows a schematic diagram of an example of environment 100 in which some embodiments of the present disclosure can be implemented. Environment 100 includes training device 110, deploying device 120, and target device 130. These devices 110-130 may be any devices with computing power. As an example, these devices 110-130 may be personal computers, tablet computers, wearable devices, cloud servers, mainframes, distributed computing systems, and the like. It should be understood that, for clearness, devices 110-130 are shown as various devices, but in an implementation, at least some of devices 110-130 (e.g., devices 110 and 120) may be identical devices.

Training device 110 is configured to train a neural network. The neural network may be any appropriate network, e.g., a deep learning network such as Mobilenet v1, Mobilenet v2, and the like. The neural network may be compressed to save storage resources occupied by a parameter of the neural network and an operation workload of the neural network. For example, non-critical channels in the neural network may be pruned to reduce the operation workload thereof. Specifically, the non-critical channels may be pruned based on contributions of a channel to a final training result. Therefore, the neural network may be interchangeably referred to as a prunable neural network below.

In view of this, training device 110 may determine a group of optimal network structures for a prunable neural network under various operation workloads based on training data set 140 (e.g., Cifar-10, Cifar-100, and the like). Therefore, training device 110 may train the prunable neural network based on the training data set and the group of optimal network structures, such that trained prunable neural network 150 has, under a given operation workload, an optimal network structure corresponding to the given operation workload. It should be understood that these optimal network structures have nothing to do with target device 130 to be deployed with the trained prunable neural network. In other words, for various target devices, an identical optimal network structure is determined as long as the desired operation workloads are the same. In this way, for various target devices, it is not necessary to determine optimal network structures respectively, such that it is not necessary to train the prunable neural network respectively. Further, deploying device 120 is configured to deploy the prunable neural network on target device 130. Specifically, deploying device 120 may acquire trained prunable neural network 150. Further, deploying device 120 may determine a target operation workload to be applied to target device 130 based on information 160 and expected performance 170 related to target device 130. Therefore, deploying device 120 may deploy the prunable neural network to target device 130 based on the target operation workload, where deployed prunable neural network 180 has an optimal network structure corresponding to the target operation workload.

In this way, the prunable neural network having the optimal network structure corresponding to the target operation workload may be deployed on target device 130 based on the target operation workload required by target device 130. As mentioned above, in a process of training the prunable neural network, the prunable neural network having optimal network structures for various operation workloads has been determined. In this case, the prunable neural network having the optimal network structure corresponding to the target operation workload may be directly selected in a deployment process. Therefore, for various target devices, it is not necessary to train the prunable neural network respectively. On the contrary, the trained prunable neural network may be applied to various different target devices, and therefore may be efficiently and quickly deployed onto various target devices.

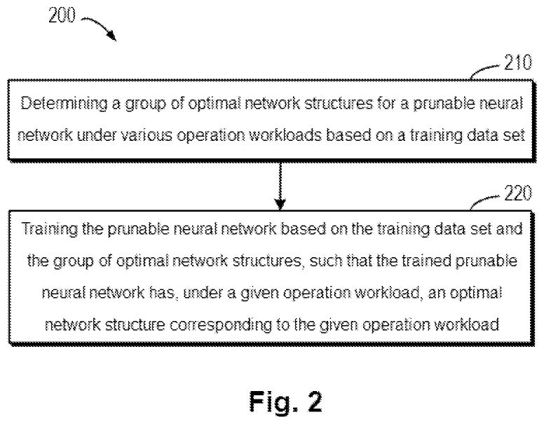

FIG. 2 shows a flowchart of method 200 for training a neural network according to some embodiments of the present disclosure. Method 200 may be implemented by training device 110 as shown in FIG. 1. Alternatively, method 200 may also be implemented by other entities than training device 110. It should be understood that method 200 may further include additional steps that are not shown and/or may omit steps that are shown, and the scope of the present disclosure is not limited in this respect.

In step 210, training device 110 determines a group of optimal network structures for a prunable neural network under various operation workloads based on training data set 140. The optimal network structure may be determined by Learnable Global Rank (LeGR). The LeGR is an effective method for obtaining a trade-off curve between operation workload and accuracy. The LeGR does not search for a percentage of a to-be-pruned channel on each layer, but searches for layer-by-layer affine transformation on a channel paradigm, such that the transformed channel paradigm may globally rank channels across layers. The globally ranked structure provides an effective method for exploring a Convolutional Neural Network (CNN) with various constraint levels, which may be implemented only by setting a threshold for the lowest-ranked channel. In view of this, in some embodiments, training device 110 may determine a group of candidate network structures for the prunable neural network under a first operation workload. Further, training device 110 may select a candidate network structure with the best performance from the group of candidate network structures for use as an optimal network structure corresponding to the first operation workload.

In some embodiments, in order to determine the group of candidate network structures, training device 110 may determine a complete network structure of the prunable neural network under a maximum operation workload. Training device 110 may determine a group of compression modes usable for the complete network structure based on the first operation workload and the maximum operation workload. Therefore, training device 110 may compress the complete network structure based on the group of compression modes to determine the group of candidate network structures.

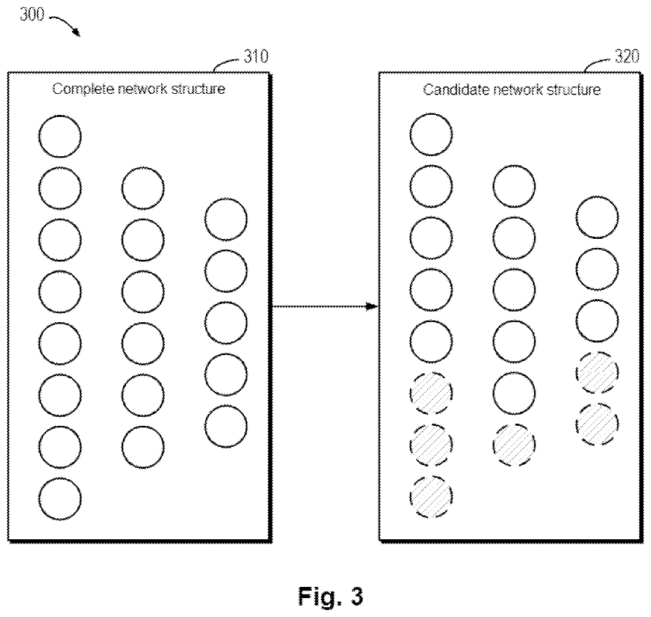

FIG. 3 shows a schematic diagram of an example of compressing 300 a prunable neural network according to some embodiments of the present disclosure. As shown in FIG. 3, in a compression mode, complete network structure 310 under a maximum operation workload may be compressed to candidate network structure 320 under a first operation workload. In said candidate network structure 320, 3 channels in a 1st layer of the prunable neural network are pruned, 1 channel in a 2nd layer thereof is pruned, and 2 channels in a 3rd layer thereof are pruned. It should be understood that complete network structure 310 and candidate network structure 320 are only examples. The prunable neural network may have any suitable complete network structure, and may be compressed in any suitable compression mode.

It can be seen that when the prunable neural network is compressed, each layer of the prunable neural network is not compressed to an identical ratio, but different effects of different layers on a performance of the prunable neural network are considered. In this way, an optimal network structure with the best performance can be determined for various operation workloads.

Referring back to FIG. 2, in step 220, training device 110 trains the prunable neural network based on the training data set and the group of optimal network structures, such that the trained prunable neural network has, under a given operation workload, an optimal network structure corresponding to the given operation workload.

In some embodiments, training device 110 may iteratively train the prunable neural network. In an iterative process, training device 110 may determine an operation workload set for training the prunable neural network. The operation workload set may include a maximum operation workload, a minimum operation workload, and an intermediate operation workload selected between the maximum operation workload and the minimum operation workload. For example, the maximum operation workload, the minimum operation workload, and the intermediate operation workload may be 100%, 30%, and 50% of a total operation workload, respectively.

Training device 110 may determine a first optimal network structure corresponding to the maximum operation workload, a second optimal network structure corresponding to the minimum operation workload, and a third optimal network structure corresponding to the intermediate operation workload from the group of optimal network structures. For example, the first optimal network structure may be the complete network structure. The second optimal network structure may be a network structure in which, with respect to the complete network structure, 50% of the channels in the 1st layer are pruned, 80% of the channels in the 2nd layer are pruned, and 60% of the channels in the 3rd layer are pruned. The third optimal network structure may be a network structure in which, with respect to the complete network structure, 20% of the channels in the 1st layer are pruned, 60% of the channels in the 2nd layer are pruned, and 40% of the channels in the 3rd layer are pruned.

Therefore, training device 110 may train the prunable neural network based on the training data set and the first optimal network structure corresponding to the maximum operation workload. Then, training device 110 may further train the prunable neural network based on the training data set, the second optimal network structure corresponding to the minimum operation workload, and the third optimal network structure corresponding to the intermediate operation workload. This is because the first optimal network structure corresponding to the maximum operation workload is more complex and more accurate, e.g., may be the complete network structure. In this case, a result of training the prunable neural network based on the training data set and the first optimal network structure may be used as reference for further training.

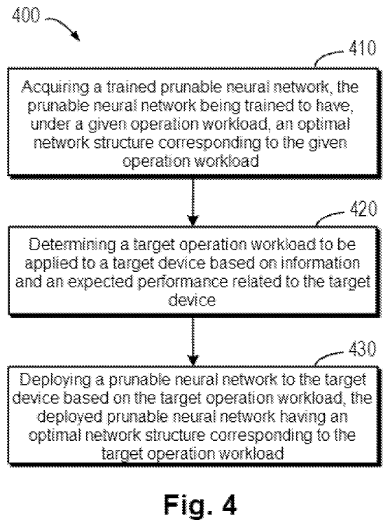

A training process of the prunable neural network has been described above. A deploying process of the trained prunable neural network will be described below with reference to FIG. 4.

FIG. 4 shows a flowchart of an example of method 400 for deploying a neural network according to some embodiments of the present disclosure. Method 400 may be implemented by deploying device 120 as shown in FIG. 1. Alternatively, method 400 may also be implemented by other entities than deploying device 120. It should be understood that method 400 may further include additional steps that are not shown and/or may omit steps that are shown. The scope of the present disclosure is not limited in this respect.

In step 410, deploying device 120 acquires trained prunable neural network 150. The prunable neural network is trained to have, under a given operation workload, an optimal network structure corresponding to the given operation workload. For example, the prunable neural network has a first optimal network structure when the given operation workload is 100% of a total operation workload, the prunable neural network has a second optimal network structure when the given operation workload is 30% of the total operation workload, and the prunable neural network has a third optimal network structure when the given operation workload is 50% of the total operation workload. It should be understood that these given operation workloads and the corresponding optimal network structures thereof are only examples. In fact, for each appropriate operation workload, there may be a corresponding optimal network structure.

In step 420, deploying device 120 determines a target operation workload to be applied to target device 130 based on information 160 and expected performance 170 related to target device 130, e.g., 50% of a total operation workload. For example, information 160 related to target device 130 may be an operational capability of target device 130. The expected performance may include an expected accuracy and/or expected response time.

In step 430, deploying device 120 deploys prunable neural network 180 to target device 130 based on the target operation workload. Deployed prunable neural network 180 has an optimal network structure corresponding to the target operation workload. For example, the target operation workload is 50% of the total operation workload. Therefore, the prunable neural network having the third optimal network structure may be deployed on target device 130.

In this way, the prunable neural network having the optimal network structure corresponding to the target operation workload may be deployed on target device 130 based on the target operation workload required by target device 130. As mentioned above, in a process of training the prunable neural network, the prunable neural network having optimal network structures for various operation workloads has been determined. In this case, the prunable neural network having the optimal network structure corresponding to the target operation workload may be directly selected in a deployment process. Therefore, for various target devices, it is not necessary to train the prunable neural network respectively. On the contrary, the trained prunable neural network may be applied to various different target devices, and therefore may be efficiently and quickly deployed onto various target devices.

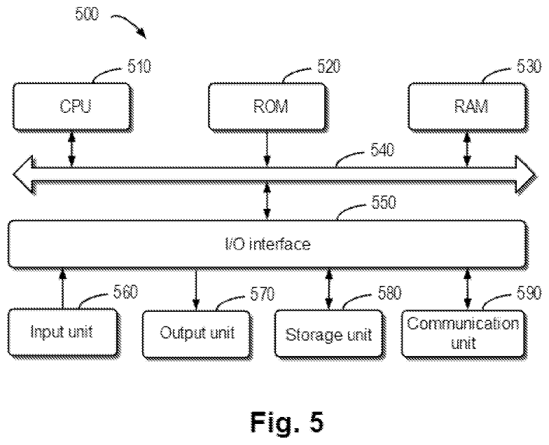

FIG. 5 shows a schematic block diagram of example device 500 that may be configured to implement embodiments of contents of the present disclosure. For example, training device 110 and deploying device 120 shown in FIG. 1 may be implemented by device 500. As shown in the figure, device 500 includes central processing unit (CPU) 510, which may execute various appropriate actions and processes in accordance with computer program instructions stored in read-only memory (ROM) 520 or computer program indications loaded into random-access memory (RAM) 530 from storage unit 580. RAM 530 may further store various programs and data required by operations of device 500. CPU 510, ROM 520, and RAM 530 are connected to each other through bus 540. Input/output (I/O) interface 550 is also connected to bus 540.

A plurality of components in device 500 is connected to I/O interface 550, including: input unit 560, such as a keyboard and a mouse; output unit 570, such as various types of displays and speakers; storage unit 580, such as a magnetic disk and an optical disk; and communication unit 590, such as a network card, a modem, and a wireless communication transceiver. Communication unit 590 allows device 500 to exchange information/data with other devices via a computer network, e.g., the Internet, and/or various telecommunication networks.

The processes described above, such as process 200 and process 400, may be executed by CPU 510. For example, in some embodiments, process 200 and process 400 may be implemented as a computer software program that is tangibly included in a machine-readable medium, such as storage unit 580. In some embodiments, a part or all of the computer program may be loaded and/or installed onto device 500 via ROM 520 and/or communication unit 590. When the computer program is loaded into RAM 530 and executed by CPU 510, one or more actions of process 200 and process 400 described above may be executed.

Illustrative embodiments of the present disclosure include a method, an apparatus, a system, and/or a computer program product. The computer program product may include a computer-readable storage medium, which carries computer-readable program instructions for executing various aspects of the present disclosure.

The computer-readable storage medium may be a tangible device that can hold and store instructions for use by an instruction executing device. An example of the computer-readable storage medium may include, but is not limited to: an electrical storage device, a magnetic storage device, an optical storage device, an electromagnetic storage device, a semiconductor storage device, or any suitable combination thereof. More specific examples (a non-exhaustive list) of the computer-readable storage medium may include: a portable computer disk, a hard disk, a RAM, a ROM, an erasable programmable read-only memory (EPROM or flash memory), a static random-access memory (SRAM), a portable compact disk read-only memory (CD-ROM), a digital versatile disk (DVD), a memory stick, a floppy disk, a mechanical coding device, e.g., a punched card storing instructions thereon or a protruding structure within a groove, and any suitable combination of the above. The computer-readable storage medium used here is not construed as a transitory signal itself, such as a radio wave or other freely propagating electromagnetic waves, an electromagnetic wave propagating through a waveguide or other transmission media (e.g., an optical pulse through an optical cable), or an electrical signal transmitted through a wire.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or network interface in each computing/processing device receives the computer-readable program instructions from the network, and forwards the computer-readable program instructions for storage in a computer-readable storage medium in each computing/processing device.

The computer program instructions for performing the operations of the present disclosure may be an assembly instruction, an instruction set architecture (ISA) instruction, a machine instruction, a machine-related instruction, microcode, a firmware instruction, state setting data, or source code or object code compiled in any combination of one or more programming languages. The programming languages include object-oriented programming languages, such as Java, Smalltalk, and C++, and also include conventional procedural programming languages, such as the “C” language or similar programming languages. The computer-readable program instructions may be completely executed on a user's computer, partially executed on a user's computer, executed as a stand-alone software package, partially executed on a user's computer and partially executed on a remote computer, or completely executed on a remote computer or server. When a remote computer is involved, the remote computer may be connected to a user's computer through any network, including a local area network (LAN) or a wide area network (WAN), or may be connected to an external computer (e.g., connected through the Internet using an Internet service provider). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions to implement various aspects of the present disclosure.

Various aspects of the present disclosure are described herein with reference to the flowcharts and/or block diagrams of the method, the apparatus (system), and the computer program product according to the embodiments of the present disclosure. It should be understood that each block in the flowcharts and/or block diagrams as well as a combination of blocks in the flowcharts and/or block diagrams may be implemented by using the computer-readable program instructions.

The computer-readable program instructions may be provided to a processing unit of a general-purpose computer, a special-purpose computer, or other programmable data processing apparatuses to produce a machine, such that the instructions, when executed by the processing unit of the computer or other programmable data processing apparatuses, generate an apparatus for implementing the functions/actions specified in one or more blocks in the flowcharts and/or block diagrams. The computer-readable program instructions may also be stored in a computer-readable storage medium. The instructions cause the computer, the programmable data processing apparatuses, and/or other devices to operate in a particular manner, such that the computer-readable medium storing the instructions includes a manufactured product, including instructions for implementing various aspects of the functions/actions specified in one or more blocks in the flowcharts and/or block diagrams.

The computer-readable program instructions may also be loaded onto a computer, other programmable data processing apparatuses, or other devices, such that a series of operation steps are performed on the computer, other programmable data processing apparatuses, or other devices to produce a computer implemented process. Thus, the instructions executed on the computer, other programmable data processing apparatuses, or other devices implement the functions/actions specified in one or more blocks in the flowcharts and/or block diagrams.

The flowcharts and block diagrams in the accompanying drawings show the architectures, functions, and operations of possible implementations of the system, the method, and the computer program product according to a plurality of embodiments of the present disclosure. In this regard, each of the blocks in the flowcharts or block diagrams may represent a module, a program segment, or an instruction portion, said module, program segment, or instruction portion including one or more executable instructions for implementing specified logic functions. In some alternative implementations, the functions denoted in the blocks may occur in a sequence different from the sequences shown in the figures. For example, any two consecutive blocks may be executed substantially in parallel, or they may sometimes be executed in a reverse sequence, depending on the functions involved. It should also be noted that each block in the block diagrams and/or flowcharts as well as a combination of blocks in the block diagrams and/or flowcharts may be implemented using a dedicated hardware-based system executing specified functions or actions, or by a combination of dedicated hardware and computer instructions.

Illustrative embodiments of the present disclosure have been described above. The above description is illustrative, rather than exhaustive, and is not limited to the disclosed embodiments. Numerous modifications and alterations are apparent to those of ordinary skills in the art without departing from the scope and spirit of various illustrated embodiments. The selection of terms used herein is intended to best explain the principles and practical applications of the embodiments or technological improvements on technologies in the market, and to otherwise enable persons of ordinary skill in the art to understand the embodiments disclosed herein.

What is claimed is:

1. A method for training a neural network, comprising:
determining a group of optimal network structures for a prunable neural network under various operation workloads based on a training data set; and
training the prunable neural network based on the training data set and the group of optimal network structures, such that the trained prunable neural network has, under a given operation workload, an optimal network structure corresponding to the given operation workload.

2. The method according to claim 1, wherein determining the group of optimal network structures comprises:
determining a group of candidate network structures for the prunable neural network under a first operation workload; and
selecting a candidate network structure with the best performance from the group of candidate network structures for use as an optimal network structure corresponding to the first operation workload.

3. The method according to claim 2, wherein determining the group of candidate network structures comprises:
determining a complete network structure for the prunable neural network under a maximum operation workload;
determining a group of compression modes usable for the complete network structure based on the first operation workload and the maximum operation workload; and
compressing the complete network structure based on the group of compression modes to determine the group of candidate network structures.

4. The method according to claim 1, wherein training the prunable neural network comprises iteratively executing following operations at least once:
determining an operation workload set for training the prunable neural network, the operation workload set comprising a maximum operation workload, a minimum operation workload, and an intermediate operation workload selected between the maximum operation workload and the minimum operation workload;
determining a first optimal network structure corresponding to the maximum operation workload, a second optimal network structure corresponding to the minimum operation workload, and a third optimal network structure corresponding to the intermediate operation workload from the group of optimal network structures;
training the prunable neural network based on the training data set and the first optimal network structure corresponding to the maximum operation workload; and
further training the prunable neural network based on the training data set, the second optimal network structure corresponding to the minimum operation workload, and the third optimal network structure corresponding to the intermediate operation workload.

5. A method for deploying a neural network, comprising:
acquiring a trained prunable neural network, the prunable neural network being trained to have, under a given operation workload, an optimal network structure corresponding to the given operation workload;
determining, based on information and an expected performance related to a target device, a target operation workload to be applied to the target device; and
deploying the prunable neural network to the target device based on the target operation workload, the deployed prunable neural network having an optimal network structure corresponding to the target operation workload.

6. The method according to claim 5, wherein the expected performance comprises at least one of an expected accuracy and expected response time.

7. An electronic device, comprising:
at least one processing unit; and
at least one memory, the at least one memory being coupled to the at least one processing unit and storing an instruction for execution by the at least one processing unit, the instruction, when executed by the at least one processing unit, causing the device to execute actions, the actions comprising:
determining a group of optimal network structures for a prunable neural network under various operation workloads based on a training data set; and
training the prunable neural network based on the training data set and the group of optimal network structures, such that the trained prunable neural network has, under a given operation workload, an optimal network structure corresponding to the given operation workload.

8. The device according to claim 7, wherein determining the group of optimal network structures comprises:
determining a group of candidate network structures for the prunable neural network under a first operation workload; and
selecting a candidate network structure with the best performance from the group of candidate network structures for use as an optimal network structure corresponding to the first operation workload.

9. The device according to claim 8, wherein determining the group of optimal network structures comprises:
determining a complete network structure for the prunable neural network under a maximum operation workload;
determining a group of compression modes usable for the complete network structure based on the first operation workload and the maximum operation workload; and
compressing the complete network structure based on the group of compression modes to determine the group of candidate network structures.

10. The device according to claim 7, wherein training the prunable neural network comprises iteratively executing following operations at least once:
determining an operation workload set for training the prunable neural network, the operation workload set comprising a maximum operation workload, a minimum operation workload, and an intermediate operation workload selected between the maximum operation workload and the minimum operation workload;
determining a first optimal network structure corresponding to the maximum operation workload, a second optimal network structure corresponding to the minimum operation workload, and a third optimal network structure corresponding to the intermediate operation workload from the group of optimal network structures;
training the prunable neural network based on the training data set and the first optimal network structure corresponding to the maximum operation workload; and
further training the prunable neural network based on the training data set, the second optimal network structure corresponding to the minimum operation workload, and the third optimal network structure corresponding to the intermediate operation workload.

11. The device according to claim 7, wherein the actions further comprise:
acquiring a trained prunable neural network, the prunable neural network being trained to have, under a given operation workload, an optimal network structure corresponding to the given operation workload;
determining, based on information and an expected performance related to a target device, a target operation workload to be applied to the target device; and
deploying the prunable neural network to the target device based on the target operation workload, the deployed prunable neural network having an optimal network structure corresponding to the target operation workload.

12. The device according to claim 11, wherein the expected performance comprises at least one of an expected accuracy and expected response time.

13. A computer program product, the computer program product being tangibly stored on a non-transitory computer-readable medium and comprising a machine-executable instruction, the machine-executable instruction, when executed, causing a machine to execute steps of the method according to claim 1.

14. A computer program product, the computer program product being tangibly stored on a non-transitory computer-readable medium and comprising a machine-executable instruction, the machine-executable instruction, when executed, causing a machine to execute steps of the method according to claim 5.
